(19) United States
(12) Patent Application Publication
(10) Pub. No.: US 2016/0003458 A1
(43) Pub. Date: Jan. 7, 2016

(54) SUPPORT BASE FOR LIGHT FITTINGS

(71) Applicant: Flavia Cecilia QUIÑONES VAZQUEZ, (US)

(72) Inventor: Flavia Cecilia QUIÑONES VAZQUEZ, Distrito Federal (MX)

(21) Appl. No.: 14/765,286

(22) PCT Filed: Jan. 24, 2014
(86) PCT No.: PCT/IB2014/058531

§ 371 Date: Jul. 31, 2015

(30) Foreign Application Priority Data
Feb. 1, 2013 (MX) MX/A/2013/006540

(51) Int. Cl. F21V 21/02

(52) U.S. Cl. CPC F21V 21/02

(57) ABSTRACT

Support base for light fittings suitable to be used in a fast, practical, functional and cost-effective manner. The support comprises a main body formed by two simple identical profiles, which have a plurality of elements. The simple profiles are attached together by a fastening rail comprised by a “T”-shaped element; and a lower attachment element, all these elements are embedded so as to create a combined profile. The combined profile is formed by the extrusion of polymers by a mechanical industrial process, wherein an action of pressing and molding of the plastic is performed through continuous flow with pressure and thrust. The recesses formed by the housing hooks and the lower attachments serve as gaps for coupling the socket components for luminaries. The fastening rail and a lower attachment body serve couple the two simple bodies.

### FIELD OF THE INVENTION

The illustrated embodiments of the present invention refer generally to bases for luminaries and more particularly, to bases for luminaries of the type comprised by the attachment of several elements which provide lightness and practicality, there is currently a wide range of supports for luminaries, however, they require a number of additional fastening elements, likewise, the commonly used supports for luminaries are comprised by a plurality of parts and materials which difficult their installation and increase their cost.

### BACKGROUNDS OF THE INVENTION

A plurality of supports for lamps are currently used, among the most common ones there are those that relating to “spring nut fastening systems”, wherein the conduit connects through a fluorescent lamp removable disk; the lamp is supported to the grooved profile by means of a spring nut and a round head stud, the line is supported by hangers. Other known fastening system is that related with the “pre-bored grooved profile fastening systems”, wherein the conduit connects through a fluorescent lamp removable disk, the lamp is supported to the grooved profile by means of an hexagonal nut, the system is supported by the hanger and the line may be attached by the junction. Other known fastening system is that related with the “removable disk connection” which provides clamping by a nipple assembled in the profile removable disk, the end, the end cover, the conduit connector and the pipeline hanger comprising the assembly. Still another known fastening system is that related with the “downward grooves connection” system, wherein the conduit enters the line by an end, the opening of the grooved profile is closed with termination pieces, the lamp is fastened and wired by a wire nut, the system is attached by a hanger and the line may be attached by the junction.

Currently, there are several proposals for support bases for luminaries. For example, U.S. Pat. No. 4,130,860 discloses a lamp support, particularly fluorescent lamps requiring a converter, such as, for example, the track lighting of a vehicle. This invention is provided with a frame that simplifies the assembly, the support including: a groove comprised by metal sheets, an isolating plate that accommodates the electric converter, the electric converter is interconnected by means of printed circuits on the isolating plate, which, in turn, is connected by means of flexible drivers to the fluorescent lamps and to a socket connected to the power supply.

A disadvantage of the support for luminaries of U.S. Pat. No. 4,130,860 is that U.S. Pat. No. 4,130,860 covers a support frame comprised by a metal plate having a series of groove-shaped folds, as well as a second isolating plate useful for accommodating the electric converter, so this support requires more elements, thereby increasing the cost when using a metal plate and an isolating plate independently, further, the support of U.S. Pat. No. 4,130,860 requires a groove plate for each luminarie, turning it into a robust and impractical frame.

US Patent application No. 2005/0148242 A1 describes a support system for fluorescent lamp, said application has at least one driver element in each end, a support base for receiving a lamp; fastening clamps suited to be connected to the power supply and arranged for receiving a driver element; a rotatory covering member mounted on the lamp support base, including an arm for holding the lamp when the rotatory member is rotated to the opened position; friction holding means cooperating with the holding means of the lamp support base when the covering member is in the closed position. However, this lamp support does not describe any isolating element, as well as a support designed for accommodating a plurality of luminaries comprised by two main bodies attached to one another by means of two joining elements.

US Patent Application No. 2008/0304267 A1 describes a stationary LEDS lamp. It includes a heatsink attached to the outer end of the LEDS base; one strips support attached to the top and bottom end of the surface of said LEDS lamp; a lamp cover installed in the inner base of the strips heatsink, patent application US 2008/0304267 A1 only discloses a support designed for dispelling the heat of the housed lamp, said heatsink is integrally formed along with the support base for lamps.

None of the documents describes a support base for luminaires having a base comprised by a profile made of plastic material, which allows for the accommodation of a plurality of luminaries on its outer face, as well as a series of reinforcement and resilience elements. Thus, there is the need for a support base for luminaires that overcomes all the problems of the supports developed in the past.

### OBJECTIVES

The main objective of the present invention is: to provide a support base for luminaires made of a corrosion resistant material, light weighted, of low cost, and which is resistant to high pressures and temperatures.

The second objective of the present invention is: to provide a support base for light fittings made with a plastic material that is resistant to the twisting, stress and bending actions when coupling the parts thereof.

The third objective of the present invention is: to provide a support base for light fittings that allows for the accommodation of a plurality of press-fitted sockets without the need for external elements such as screws and rivets.

The fourth objective of the present invention is: to provide a support base for light fittings consisting of two simple profiles, wherein both components are attached through a highly effective anchoring system to prevent their attaching components to slide with respect to the profiles.

The fifth objective of the present invention is: to provide a support base for light fittings including a plurality of notches and holding ends, enabling the housing recesses to bend without breaking.

The sixth objective of the present invention is: to provide a support base of luminaries including a fastening rail, which allows for the combined profile to be fastened to a trench without the need of fastening means such as screws or rivets.

The seventh objective of the present invention is: to provide a support base for light fittings including a lower attachment body which, besides accommodating a socket, serves as the lower attachment means between both simple profiles providing strength and resilience to the support base for light fittings, as well as the fastening of the two main bodies, without the need of fastening means such as screws or rivets.

The eighth objective of the present invention is: to provide a support base of luminaries including a housing recess formed by hook-shape edges which allows for the accommodation of at least one lamp socket without the need of fastening means such as screws or rivets.

The ninth objective of the present invention is: to provide a support base for light fittings that allow for the coupling of a cover arranged for being suited to the ends of the support base for light fittings in order to hide the inner wiring.

### BRIEF DESCRIPTION OF THE DRAWINGS OR FIGURES

The previous aspects and many of the concomitant advantages of this invention will be better understood upon reading the following detailed description and considering same along with the attached drawings, in which:

FIG. 1 shows a front view of the simple profile.

FIG. 1a shows a perspective view of the simple profile.

FIG. 2 shows a front view of the fastening rail.

FIG. 2a shows a perspective view of the fastening rail.

FIG. 3 shows a front view of the lower attachment body.

FIG. 3a shows a perspective view of the lower attachment body.

FIG. 4 shows a front view of the clamping trench.

FIG. 4a shows a perspective view of the clamping trench.

FIG. 5 shows a front view of two simple symmetric profiles without assembling.

FIG. 5a shows a perspective view of two simple symmetric profiles without assembling.

FIG. 6 is a front view of the combined profile with all its elements integrated so as to form the support base for light fittings.

FIG. 7 shows a front view of the cover used to cover the ends of the support base for light fittings.

FIG. 8 shows a front view of the cover coupled to one of the ends of the support base for light fittings.

FIG. 9 shows a perspective close-up view of the cover coupled to one of the ends of the support base for light fittings.

FIG. 10 shows a side close-up view of the cover coupled to one of the ends of the support base for light fittings.

### DETAILED DESCRIPTION OF THE INVENTION

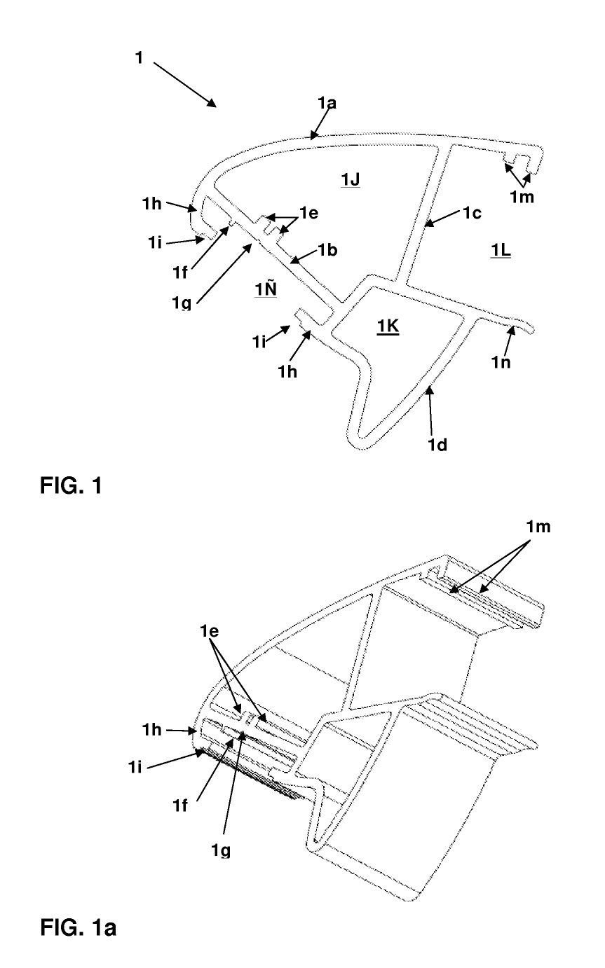

FIGS. 1 and 1a show, respectively, a front view and a perspective view of a simple profile, the simple profile consists of a plastic material main body (1).

The main body (1) of the simple profile consists of a plastic material, which is formed by the extrusion of polymers and which is carried out by means of a mechanical industrial process, wherein an action of pressing and molding of the plastic is performed through continuous flow with pressure and thrust, same that is passed through a mold responsible for providing it with the desired shape. The molten polymer (or in rubberized state) is forced through a die (also called nozzle) through the thrust generated by the rotary action of a spindle (Archimedes screw) concentrically rotates in a controlled temperatures chamber also called barrel with a millimetric gap between both elements. The polymeric material is fed by a hopper at one end of the machine and, due to the action of the thrust, it is molten, flows and mixes in the barrel to be obtained at the other side with a preset geometric profile, which, when cooled, provides stiffness and bending to the final item.

The plastic that comprises the connector body is selected, but not limited to, from the following materials: EPP, PPR or other polyolefins; (PVC, CPVC and engineering plastics), or any other thermoplastic or thermoset resin.

The main body (1) of the simple profile will be described based on FIGS. 1 and 1a, which respectively show a front view and a perspective view of the main body (1). It can be seen that this main body (1) has a top wall (1a), which totally comprises the length of the main body (1), from said top wall (1a), in points close to its ends, two downwards slanted walls (1b and 1 c) arise, same that protrude in a straight line to intersect a with a regular five-sided polygon-shaped second body (1d) defining therebetween a hollow recess (1J).

From the free ends of the wall (1b), along with the top wall (1a) and from one of the ends of the regular five-sided polygon-shaped body (1d) two hook-shaped expansions protrude (1h) encountered therebetween, further, said hooks have (1h) at its top end a stepped portion (1i).

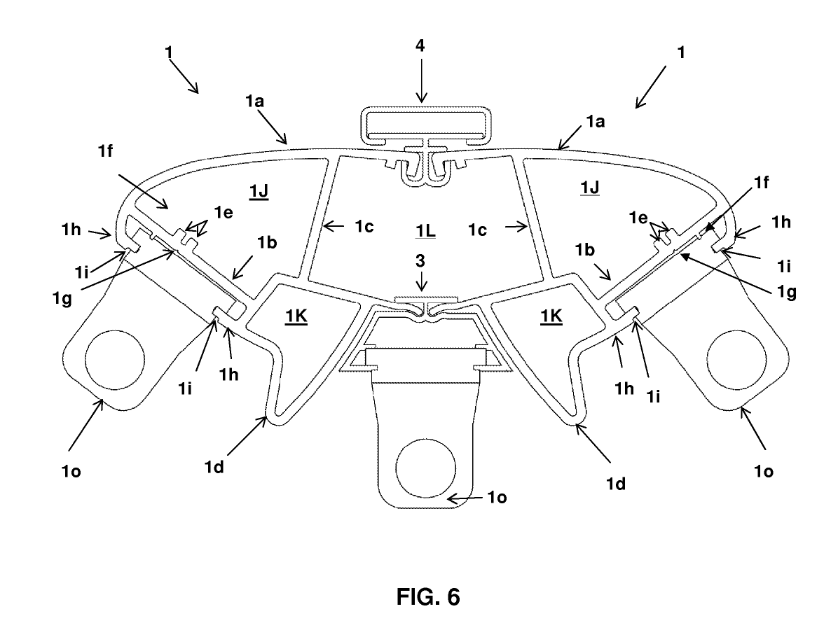

The set of hooks (1h) and wall (1b) form as a whole, a housing recess (1n), which serves as a support for a conventional socket (1o) (not shown in FIGS. 1 and 1a) so as to assemble a LEDs lamp, likewise, such housing recess (1n) is provided on its wall (1b) with one notch (1g) defined by a small cut in the thickness of said wall (1b); a pressure rib (1f) is defined over the entire length of the perpendicular-shaped body to the wall (1b), in a point close to the notch (1g), such pressure rib (1f) provides pressure to the socket (see FIG. 6, reference 10), avoiding for this to be loose inside the housing recess (1n) and thus remaining securely fastened between the hooks (1h) and the wall (1b) with respect to the stepped portion (1i) performed on the ends of the hooks (1h), they provide a better coupling to the base of the socket (1) with the surface of the hooks (1h), which along with the rib (1f) provide a firm and lasting support.

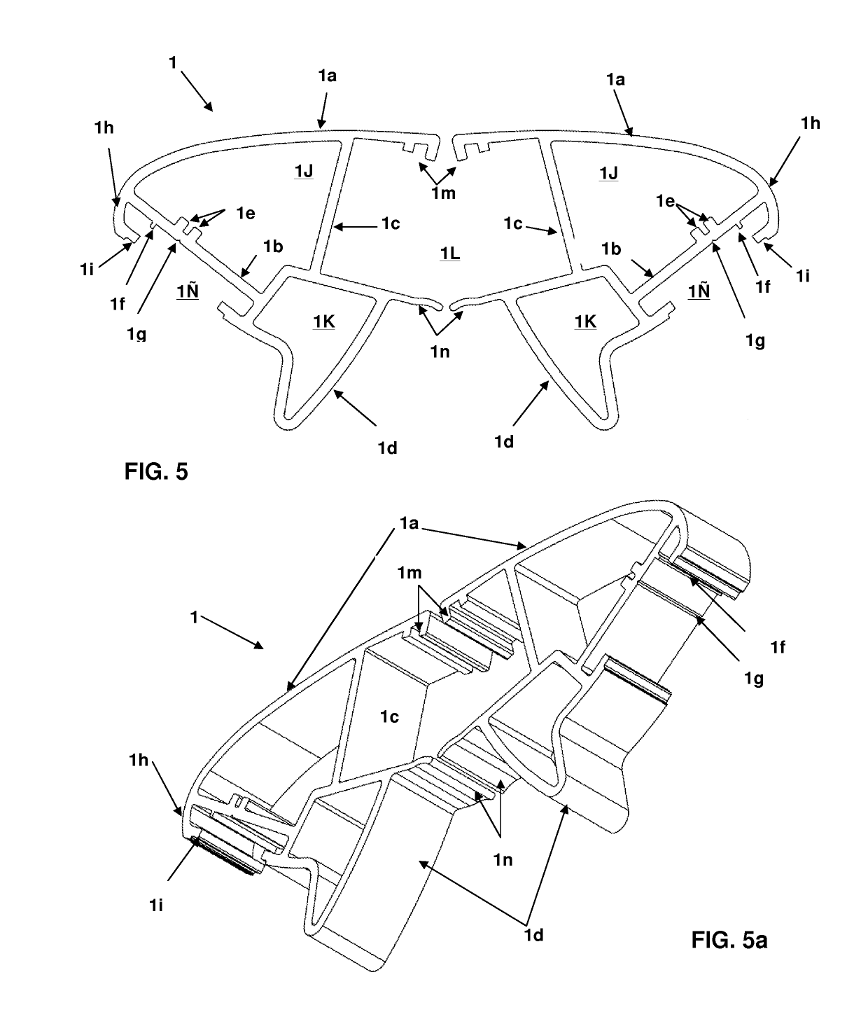

Two parallel stopper ribs (1e) are defined throughout the width of the wall (1b) within the recess (1J) and at the same height of the notch (1e), said parallel stopper ribs (1e) act together with the notch (1g) as at the moment of introducing the socket (see FIG. 5, reference 1o) in said housing recess (1ñ), the notch allows for the wall (1b) to bend so as to facilitate the entrance of the socket (1o) in said housing recess (1ñ), likewise, when the wall (1b) is bent towards the recess (1J), the stopper ribs (1e) are slanted one against the other thus preventing the wall (1b) from over-bending and the possibility of breaking.

The main body (1) comprised by the walls (1a, 1b and 1c) and the regular five-sided polygon shaped body (1d), define in the end opposite to the housing recess (1n), a second recess (1l) formed by the wall (1c), the top wall (1a) and the top part of the regular five-sided polygon shaped body (1d), said top wall end (1a) that defines the second recess (1l) has a free end comprising a pair of hook-shaped ribs for fastening (1m), formed by two parallel protrusions and perpendicular to said top wall (1a), these fastening hooks (1m) serve as attachment means between the simple profiles of each main body (1); also, the top side of the regular five-sided polygon shaped body (1d) which is part of a second recess (1l), protrudes in a straight line and parallel to the top wall (1a) until an end wherein it defines a wavy end wall (1n).

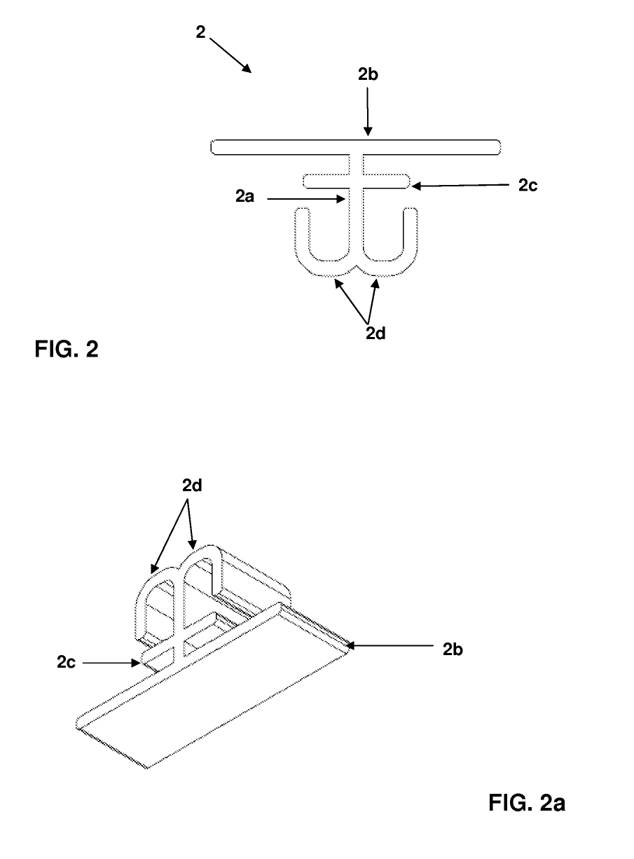

FIGS. 2 and 2a, respectively, show a front view and a perspective view of a fastening rail (2), said fastening rail (2) is made up of a shaped body made from plastic material, although it is not restricted solely to this material.

The fastening rail (2) will be now described based on FIGS. 2 and 2a which show, respectively, a front view and a perspective view of the fastening (2), wherein it may be noted that the fastening rail (2) is formed by a “T” shaped main body comprised by a vertical wall (2a) defining the main body and a first wall (2b) that is perpendicular to said vertical wall (2a), wherein, in turn, the vertical wall (2a) has a second perpendicular wall (2c) corresponding to the top part of the “T” but with a higher length with respect to the wall (2c); from the lower end of the vertical wall (2a) to hook-shaped curve edges (2d) protrude towards the perpendicular wall (2c) but in opposed direction between them.

The fastening rail (2) allows for the coupling of two main bodies (1) by means of its fastening hooks (1m), said fastening hooks (1m) being hooked between the perpendicular wall (2c) and the hook-shaped edges (2d) provided in the fastening rails (2), so that said fastening hooks (1m) remain coupled within the fastening rail (2) in a lasting and resistant manner, but at the same time it provides flexibility during the coupling; likewise, due to the arrangement of the fastening hooks (1m) and the fastening rail (2), it is possible to provide resiliency to the assemble thus easing the entrance of the fastening hooks (1m) and allowing for the coupled assembly to bend or slide without the main bodies (1) being spaced apart.

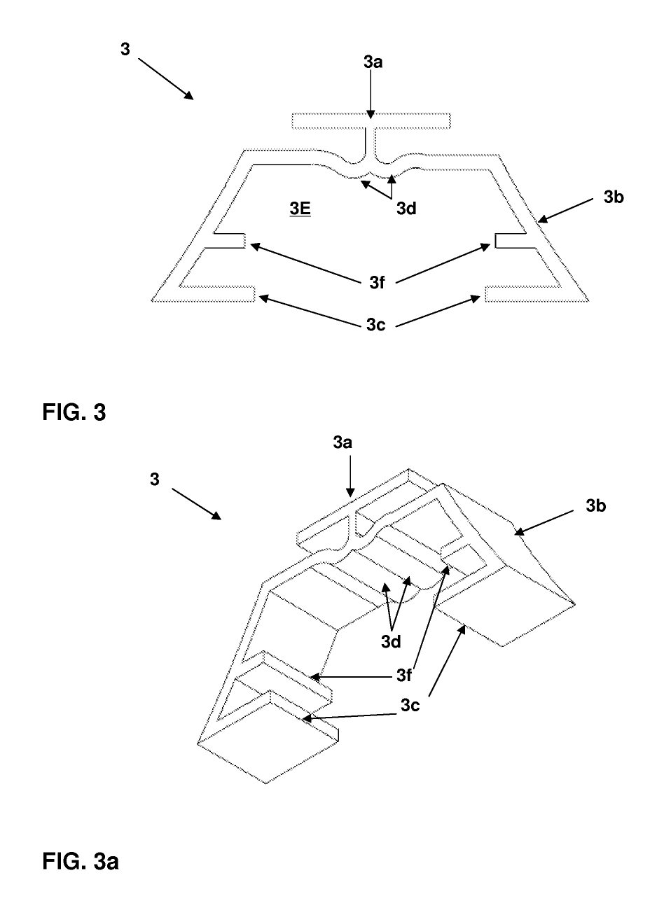

FIGS. 3 and 3a are, respectively, a front view and a perspective view of a lower attachment body (3). The lower attachment body is comprised by a plastic substantially trapezoid-shaped body (3) though it is not restricted thereto.

The lower attachment body (1) will be described based on FIGS. 3 and 3a, which respectively show a front view and a perspective view of the lower attachment body (3). It may be seen that the lower attachment body (3) defines a substantially trapezoidal shape opened by its lower end, which has a first “T”-shaped element (3a) located at the top part thereof and from which vertical wall two horizontal walls resembling an horizontal “S” protrude, same that define recesses (3d) for later being extended in a straight line up to a point where two downstream slanted walls (3b) arise, which resemble the sides of the trapezoid, from each end of said slanted walls (3b), a first wall (3d) is extended towards the inside of the body, at each side of the walls (3b); finally, two short horizontal walls (3f) are defined in parallel and on top of the first walls (3c).

The lower attachment body (3) allows for the coupling of two main symmetrical bodies (1), by inserting the wavy end walls (1n) between the “T”-shaped body “T” (3a) and the horizontal “S”-shaped walls (3d) of the lower attachment body (3), providing a lasting and resistant attachment which provides stiffness and resilience to the assembly. Thanks to the wavy shape of the ends (1n), it is possible to perform the easy entrance of these recesses (3d) formed in the lower attachment body (3); the assembly between the lower attachment body (3) and the wavy edges (1n) defined in the main body (1) may be better appreciated in FIG. 6; also, the slanted walls (3b) of the lower attachment body (3) together with the walls (3b), form a recess (3E) which serves to accommodate a socket(see FIG. 6, reference 1o) between the two pairs of perpendicular walls (3c and 3f), allowing for the easy entrance of the socket (1o) through the bending of the walls (3c and 3f), also, thanks to the arrangement thereof, it is possible to accommodate the socket (1o) within the recess (3e) formed in the lower attachment body (3), in a secure and lasting manner thereby enabling the system to bend or twist without the socket (1o) being uncoupled.

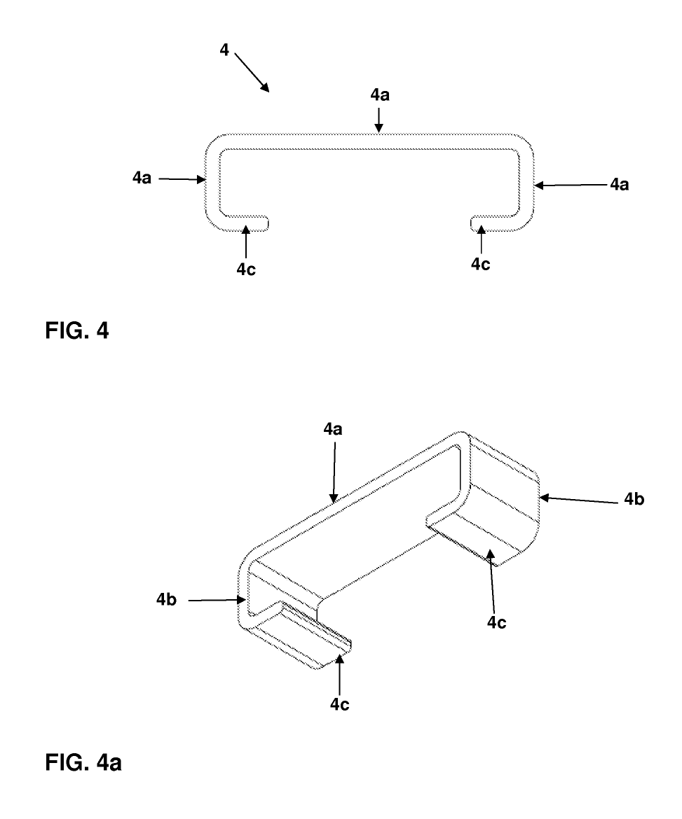

FIGS. 4 and 4a show respectively a front view and a perspective view of a clamping trench (4), said clamping trench (4) is comprised by a plastic material substantially “C” shaped body (4),though it is not limited to this material only.

The clamping trench (4) will be described based on FIGS. 4 and 4a, which respectively show a front view and a perspective view of the clamping trench (4). It may be seen that the body of the clamping trench (4) is defined by a piece that has a straight wall (4a) which ends protrude perpendicularly to the wall (4a) defining two parallel walls (4b), likewise, the free ends of the parallel walls (4b) are extended for defining two straight walls (4c) which protrude towards the center of the trench (4) and in parallel to the wall (4a), said walls (4c) serve as a hook.

The clamping trench (4) defines a housing recess between the walls (4a, 4b and 4c) which allows for accommodating the first perpendicular wall (2b) of the fastening rail (2), wherein said assembly is performed solely by pressure, which removes the need of additional fastening elements such as screws, glue or rivets. Also, the assembly allows for the fastening of the perpendicular wall (2b) of the fastening rail (2) by means of the trench (4) with any wall or ceiling in an easy, fast and cost-effective manner using fastening elements which are commonly known and used.

FIGS. 5 and 5a show, respectively, a front view and a perspective view of two unassembled symmetrical profiles (1), through FIGS. 5 and 5a one may identify all the parts conforming same with respect to the top wall (1a), the slanted walls (1b and 1c), fastening hooks (1m), pressurre ribs (1f), notch (1g), hooks ends (1h), stepped portion in the hook ends (1i), stopper ribs (1e) and wavy end walls (1n). As well as the recesses (1n), (1j), (1l) and (1k), defined by its various elements, which are shown in FIG. 5.

FIG. 6 shows the anchoring system between two main symmetrical bodies (1) and the attachment components with respect to the fastening rail (2), the lower attachment body (3) and the clamping trench (4); said FIG. 6 shows two main symmetrical bodies (1), wherein two main bodies (1) are attached therewith in its top part by a fastening rail (2), which allows for the assembly of the fastening hooks (1m) protruding at the ends of each main body (1), said fastening ends (1m) are inserted between the second perpendicular wall (2c) and the hook-shaped edges (2d), thereby keeping the fastening ends (1m) attached to the fastening rail (2) in a firm and lasting manner, while providing resilience, bending and strength to each main body (1), as the fastening hooks (1m) have a slight slanted shape, this enables the top wall (1a) to pivot within the space comprised by the perpendicular wall (2b) and the hook-shaped edges (2d), so said main bodies (1) are bent from top to bottom without detaching, thus easing the transportation and installation of the support base for light fittings. Regarding the attachment of the main bodies (1), the proposed support base for light fittings has a second attachment point which is realized by a lower attachment body (3), said lower attachment body (3) allows for the attachment of the lower ends of the main bodies (1), as the wavy ends (1n) provided in each main body (1) are assembled to the lower attachment body (3), said lower attachment body (3) being accommodated between the horizontal wall of the “T” shaped body (3a) and the shaped horizontal walls defining recesses (3d); thanks to the “S” shaped arrangement which forms recesses (3d), the wavy ends (1n) may be inserted in a simple, fast and safe manner, allowing for the wavy end (1n) to be accommodated in the recesses (3d), thanks to this assembly, it is possible to provide the lower end of the support base for light fittings with a bending movement, as the attachment of the recesses (3d) and the wavy ends (1b) provide strength to the system while avoiding the detachment of the main bodies (1), as a point of the wavy end (3d) abuts with the perpendicular wall (3a), thus allowing a buffering movement of the support base for light fittings with no risk of detaching of the elements. As it may be seen from FIG. 6, the recesses (1ñ) formed en each main body (1) and the recess (3E) formed in the lower attachment body (3) allow for the accommodation of at least 3 sockets (1o) for luminaries.

Likewise, FIG. 6, the proposed support base for light fittings is comprised by a series of elements which main base is two main bodies (1) made up of a plastic material, with no restriction to this material, by means of an extrusion process so as to provide a lighter support, cost-effective and resistant to high temperatures, also, it allows for the isolation of the electric connections with no additional means.

The main bodies (1) are comprised by a main profile having a top wall (1a) comprising the total length of the main body (1), from said top wall (1a) and from two points close to its ends, two downwards slanted walls (1b and 1c) arise which protrude in a straight line until the intersection with a regular five-sided polygon shaped body (1d) forming therebetween a recess (1j), besides the free ends of the wall (1b) along with the top wall (1a) and from one of the ends of the regular five-sided polygon (1d), two extensions in the shape of encountered hooks (1h) are formed, said hooks (1h) have in its top end a notch (1i), regarding the set of hooks (1h) and the wall (1b), these elements form a housing recess (1ñ) which serves as support for a support socket (1o) for a LEDS lamp, likewise, said housing recess (1ñ) comprises a notch (1g) on top of the wall (1b) formed by a small cut performed in the width of the wall (1b), a pressure rib (1b) in a point close to the notch (1g), said pressure rib (1f) provides pressure to the socket (1o) thus avoiding the socket to be loose within the housing recess (1ñ), and thus, to remain securely fastened between the hooks (1h) and the wall (1b), the notches (1i) performed on top of the ends of the hooks (1h) provide a better coupling of the socket (1o) with the surface of said hooks (1h) and along with the rib (1f), they provide a long lasting support.

Two parallel stopper ribs (1e) are defined on the wall (1b) within the recess (1j) at the same height of the notch (1e), said ribs act together with the notch as at the moment of introducing the socket in said housing recess (1ñ), the notch allows for the wall (1b) to bend so as to allow for the easy entrance of the socket (1o) in said housing recess (1ñ), likewise, when the wall (1b) is bent, the stopper ribs (1e) are slanted one against the other thus preventing the wall (1b) from over-bending and the possibility of breaking.

The main body (1) comprised by the walls (1a, 1b and 1c) and the regular five-sided polygon (1d), define in the end opposite to the housing recess (1n), a second recess (1l) formed by the wall (1c), the top wall (1a) and one side of the regular five-sided polygon (1d), said top wall end (1a) that defines the second recess (1l) has a pair of fastening hooks (1m) defined by two parallel perpendicular protrusions that serve as the attachment means between two simple profiles of each main body (1); also, the side of the regular five-sided polygon (1d) which is part of the second recess (1l), protrudes in a straight line and parallel to the top wall (1a) until an end wherein it defines a wavy end wall (1n).

Said main bodies (1) are attached in its top end by means of a fastening rail (2) which holds the fastening hooks (1m) between the perpendicular wall (2c) and the hook-shaped edges (2d) avoiding the split of the fastening hooks (1m) due to the weight of the luminaries, besides being a coupling mean, the fastening rail (2) is assembled in the clamping trench (4) bye the first perpendicular wall (2b), in turn, said clamping trench (4) allows to assemble the support base for light fittings to any wall or ceiling by means of a known fastening means. In order to achieve an assembly between the main symmetrical bodies (1), a second fastening means has been selected, this is performed by the lower attachment body (3) which not only attaches the main symmetrical bodies (1) by their wavy end polygon wall (1n), but this lower attachment body (3) serves as the housing for a third socket (1o) which is accommodated in the recess (3e) formed in the lower attachment body (3), finally, a pair of sockets (1o) are fastened to the recesses (1ñ) with which the support base for light fittings comprises at least 3 sockets.

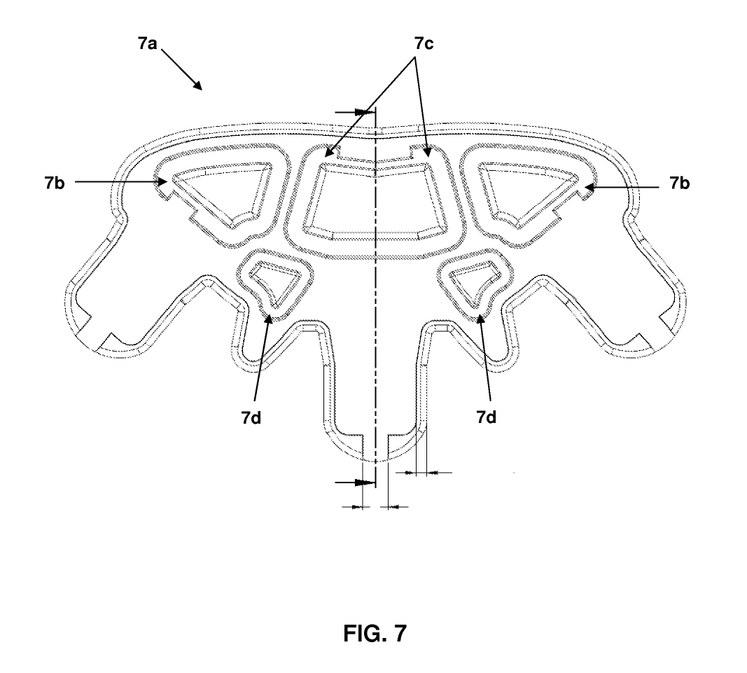

FIG. 7 shows the back front view of a cover (7a) that has the same arrangement than the ends of the support base for light fittings formed by the coupling of the main bodies (1) with the fastening rail (2), the lower attachment body (3) and the clamping trench (4). Likewise, said cover (7a) comprises inside it two substantially triangular-shaped rims (7b) in each top end, one substantially rectangular-shaped central rim (7c) and two rims with the body shaped as a five-sided polygon (7d), said rims (7b) are sized so as to be introduced in the recesses (1j) defined in the main bodies (1), in turn, the substantially rectangular-shaped rim (7c) may be introduced in the recesses (1l) formed in the main bodies (1), and finally, the rims (7d) may be introduced in the recesses formed by the five-sided polygon shaped body (1k).

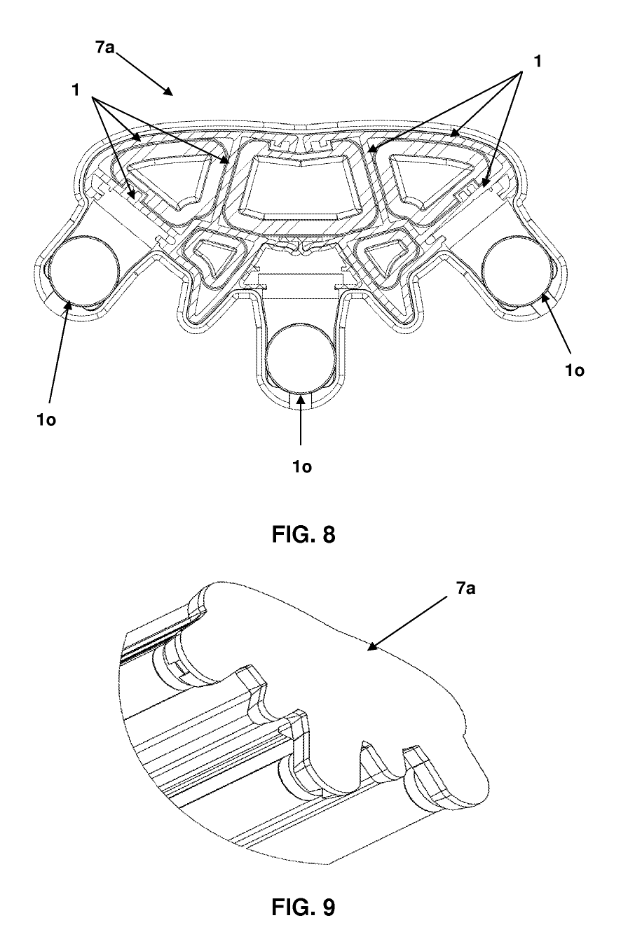

FIG. 8 shows a front view of the cover (7a) coupled to an end of the support base for light fittings by its rims (7b, 7c and 7d).

FIG. 9 shows a perspective close-up view of the cover (7a) coupled to one of the ends of the support base for light fittings.

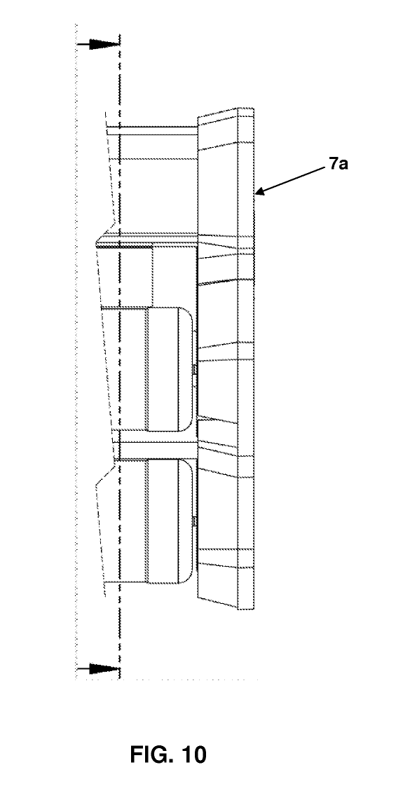

Finally, FIG. 10 shows a side close-up view of the cover (7a) coupled to an end of the support base for light fittings.

An embodiment of the invention is based on the fact that it may comprise more than three sockets (1o) by a change in the arrangement of the lower attachment body (3) as, thanks to the gap defined by the regular five-sided polygon shaped main bodies, there is provided the sufficient gap for locating a lower attachment body (3) comprising two or more housing recesses (3e).

Another embodiment of the invention, allows to realize that the walls surrounding the structure of the simple profiles may have any shape with straight, curve, sharp or the like ends.

Still another embodiment of the invention, allows to make up the support base for light fittings from any material.

Another embodiment of the invention, allows to make up the invention in any size, thus providing the possibility of coupling more luminaries.

Another embodiment of the invention, allows the pass of electric wires or circuits between the recesses (1j, 1k and 1l) formed in the main body.

Another embodiment of the invention, allows the main body (1) to have any shape that allows for the accommodation of the socket recesses in a same plane.

Another embodiment, allows making up the cover (7a) from any material.

Another embodiment of the invention, allows making up the cover (7a) with any shape that allows the coupling with the support base for light fittings.

Another embodiment of the invention, allows to reflect in the cover (7a) any figure, trademark, advertisement, etc.

1.-18. (canceled)

19. A support base for light fittings comprising two symmetrical main bodies coupled therebetween by a fastening rail and a lower attachment body, wherein said main body has a top wall that is attached to a regular five-sided polygon shaped body by means of two slanted walls; and a clamping trench which allows to accommodate the fastening rail and, in turn, allows to assemble the support base for light fittings to any wall or ceiling by any known fastening means;
a recess that allows to accommodate a socket, formed by the hook-shaped extension of the top wall, the slanted wall and a hook-shape edge of the regular five-sided polygon shaped main body;
a top wall defining a free end with two fastening hook shaped ribs;
a wavy wall end formed by the extension of the top wall of the regular five-sided polygon shaped body.

20. The support base for light fittings according to claim 19, wherein between the wall and the slanted walls a hollow recess is formed.

21. The support base for light fittings according to claim 19, wherein between the wall and the slanted walls and the extension of the top wall of the regular five-sided polygon a recess is formed.

22. The support base for light fittings according to claim 19, wherein the regular five-sided polygon shaped body defines inside it a hollow recess.

23. The support base for light fittings according to claim 19, wherein the hook-shaped extensions and the slanted wall define a recess for accommodating a socket.

24. The support base for light fittings according to claim 23, wherein the recess has a pressure rib and a notch.

25. The support base for light fittings according to claim 20, wherein the slanted wall has two stopper ribs protruding within the recess at the same height of the notch.

26. The support base for light fittings according to claim 23, wherein the hook-shaped extensions have a stepped portion in its lower end.

27. The support base for light fittings according to claim 19, wherein the fastening rail is formed by a “T”-shaped main body, comprised by a vertical wall and a first perpendicular wall, wherein, in turn, the vertical wall has a second perpendicular wall located parallel to the first perpendicular wall; and two hook-shaped edges protruding in opposite directions from the lower end of the vertical wall.

28. The support base for light fittings according to claim 19, wherein the lower attachment body defines a substantially trapezoidal shape having a first “T”-shaped element from which vertical wall two horizontal walls resembling an “S” protrude horizontally for subsequently being elongated in a straight line until the point in which two downstream slanted walls resembling the sides of a trapezoid are defined, from each end of said slanted walls, a wall extends perpendicularly towards the center of the body; two additional walls are defined in parallel to the first walls.

29. The support base for light fittings according to claim 28, wherein the lower attachment body comprises a recess for accommodating a socket.

30. The support base for light fittings according to claim 28, wherein the lower attachment body is arranged for accommodating two sockets.

31. The support base for light fittings according to claim 19, wherein the body of the clamping trench is defined by a piece that has a straight wall which ends protrude perpendicularly to the wall defining two parallel walls, likewise, from the free ends of the parallel walls two straight walls are extended which protrude towards the center of the trench and in parallel to the wall, said walls serve as a hook.

32. The support base for light fittings according to claim 19, wherein a plastic cover is coupled to the ends of the support base for light fittings.

33. The holding base for luminaries according to claim 32, wherein the cover of the support base for light fittings comprises inside it two substantially triangular-shaped rims in each top end, a substantially rectangular central rib and two ribs with the shape of the five-sided polygon shaped body.

34. The support base for light fittings according to claim 32, wherein the rims are sized so as to be introduced in the recesses defined in the main bodies, in turn, the substantially rectangular-shaped rim is be introduced in the recesses formed in the main bodies, and finally, the rims are introduced in the recesses formed by the five-sided polygon shaped body.

35. The support base for light fittings according to claim 32, wherein the cover of the support base for light fittings may be made of any material.

36. The support base for light fittings according to claim 32, wherein the cover of the support base for light fittings allows to reflect any figure, trademark, or advertisement.
